(19) United States
(12) Patent Application Publication
(10) Pub. No.: US 2026/0224440 A1
(43) Pub. Date: Aug. 6, 2026

(54) Leak Proof Blow-Fill-Seal Container Spike Port

(71) Applicant: HealthStar, Inc., Braintree, MA (US)

(72) Inventor: Peter J. DeCoste, Weymouth, MA (US)

(21) Appl. No.: 19/046,646

(22) Filed: Feb. 6, 2025

(51) Int. Cl. A61J 1/14; B65D 51/00

(52) U.S. Cl. CPC A61J 1/1406; B65D 51/002

(57) ABSTRACT

A spike port for a blow-fill-seal container that has a neck with a longitudinal bore that tapers larger from the container. A hollow head extending from the neck has a piercing point in the wall opposite the neck. Opposed gussets with optional ribs are included in the BFS mold at the parting line. A pair of knobs elongated along the bore protrude from the bore wall are positioned 180° around the bore from each other and 90° around the bore from the parting line. A tapered spike is pushed into the piercing point to penetrate into the bore where it contacts the proximal end of the knobs. As the spike continues to penetrate, the spike pushes the knobs radially outwardly to flatten into the bore wall, whereby the bore wall at the parting line collapses against the spike and the neck bore taper deforms to match the spike taper.

### STATEMENT REGARDING FEDERALLY SPONSORED RESEARCH OR DEVELOPMENT

### Not Applicable

### REFERENCE TO A SEQUENCE LISTING, A TABLE, OR A COMPUTER PROGRAM LISTING COMPACT DISK APPENDIX

Not Applicable

### BACKGROUND OF THE INVENTION

### 1. Field of the Invention

The present invention relates to blow-fill-seal containers, more particularly, to the port through which the contents are accessed.

### 2. Description of the Related Art

A blow-fill-seal (BFS) container is formed by extruding a polymer resin such as polypropylene into a tube shape called a parison. The mold then closes around the parison leaving the top of the mold open. A nozzle seals the open top and uses compressed air to hollow out the resin and form the bottle into the mold. The compressed air is injected by a blowing nozzle through a nozzle seat on one side of the container. The resulting container has a container chamber that is filled with the desired solution using a filling nozzle located inside the blowing nozzle. After filling the container, as secondary mold closes and seals the bottle with the fluid inside.

With some BFS containers, the contents are accessed by piercing a wall in a spike port with a hollow spike. Depending on how the piercing wall rips as it is being pierced, the wall may or may not form a seal around the spike to prevent leakage through the wall around the spike.

### BRIEF SUMMARY OF THE INVENTION

The present invention is a spike port designed to minimize leakage blow-fill-seal container after being pierced. The spike port has a neck that extends longitudinally away from the container from a proximal end to a distal end. The neck is tubular and tapers larger away from the container. The neck has a longitudinal bore on an axis that tapers larger from the container.

A hollow head extends axially from the distal end of the neck. The internal cavity is fully enclosed except for being contiguous with the neck bore. The wall opposite the neck is the piercing wall that provides access to the contents of the container for a hollow spike. Optionally, the piercing point is the most depressed point of a depression in the piercing wall. Preferably, the depression is round with the piercing point in the center.

Opposed gussets are included in the BFS mold at the parting line. The gussets extend from the bottom of the head to the container and prevent the neck form collapsing when pierced. Optionally, the gussets have ribs that are thicker portions of the gusset.

A pair of knobs elongated along the length of the bore protrude from the bore wall. The knobs are positioned 180° around the bore from each other and 90°around the bore from the parting line.

To use, the spike is aligned with the piercing point and pushed into the piercing wall. As the spike penetrates into the bore, it contacts the proximal end of the knobs. As the spike continues to penetrate the container, the tapered spike pushes the knobs radially outwardly. The knobs flatten into the bore wall and the bore wall at the parting line collapses against the spike, thereby deforming the neck bore taper to match the spike taper. The collapsing wall seals the bore.

Optionally, the head is stretched perpendicularly to the parting line. Stretching the head causes the parting line to move away from alignment with the neck bore with three effects. The excess plastic that can accumulate along the parting point during molding does not make it necessary to increase the amount of effort needed to pierce the piercing wall. Moving the parting line reduces the possibility that the piercing wall will split along the parting line when pierced. Stretching the head thins the material in the area of the piercing point, making the piercing wall easier to pierce.

Objects of the present invention will become apparent in light of the following drawings and detailed description of the invention.

### BRIEF DESCRIPTION OF THE DRAWINGS

For a fuller understanding of the nature and object of the present invention, reference is made to the accompanying drawings, wherein:

FIG. 1 is top perspective view of the spike port of the present invention;

FIG. 2 is a gusset side view;

FIG. 3 is a knob side view;

FIG. 4 is a gusset side cross-sectional view;

FIG. 5 is a knob side cross-sectional view;

FIG. 6 is a top cross-sectional view of the neck;

FIG. 7 is a gusset side cross-sectional view of the neck with a spike partially inserted;

FIG. 8 is a gusset side cross-sectional view of the neck with the spike fully inserted;

FIG. 9 is a top perspective view of a stretched spike port; and

FIG. 10 is a side view of the stretched spike port.

### DETAILED DESCRIPTION OF THE INVENTION

The present invention is a spike port 10 designed to minimize leakage after being pierced. The spike port 10 is for use on a blow-fill-seal container 12. The typical container 12 has an internal chamber 18 for holding its contents. A nozzle seat 14 is at one end of the container 12 and includes a transition 16 that narrows the nozzle seat 14 for the spike port 10.

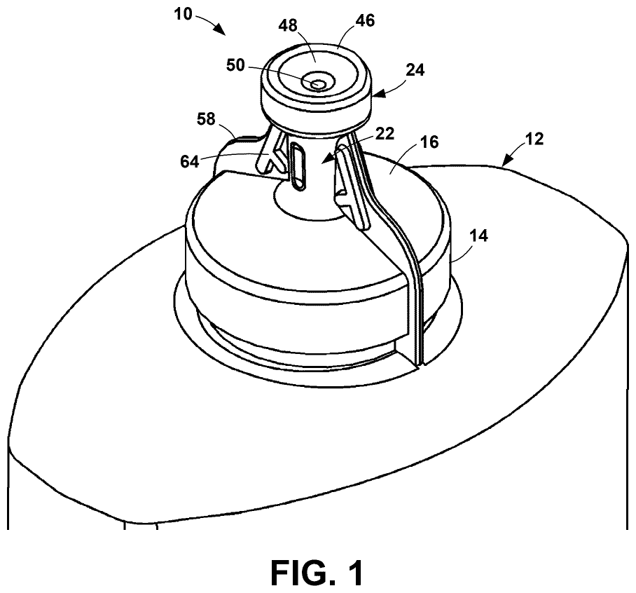

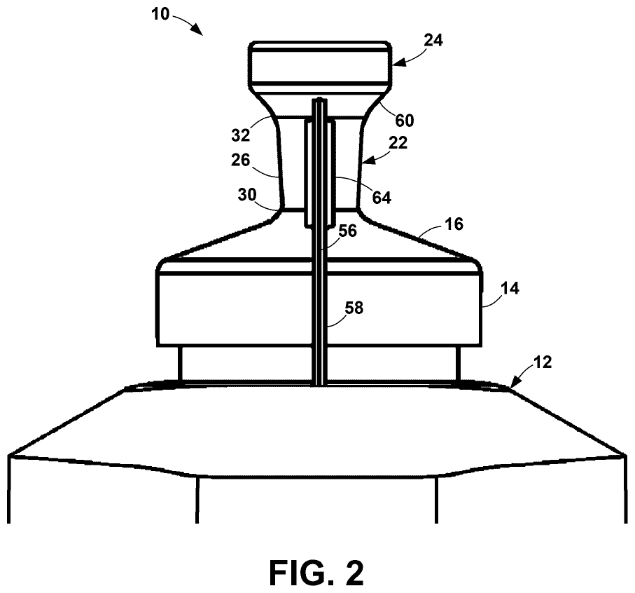

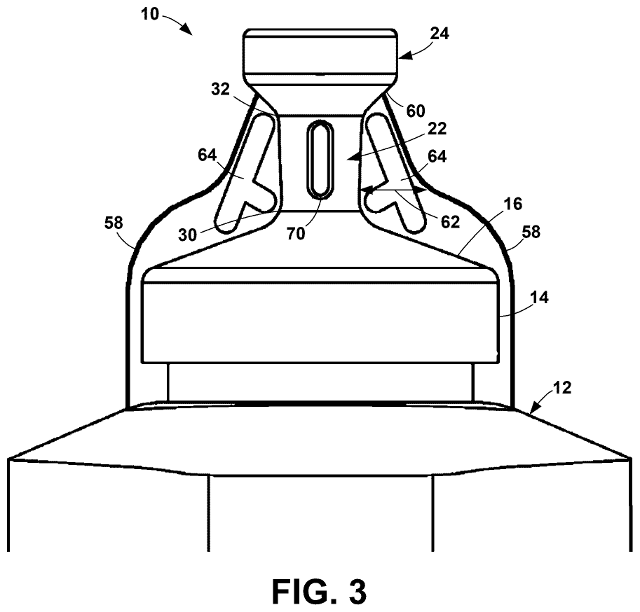

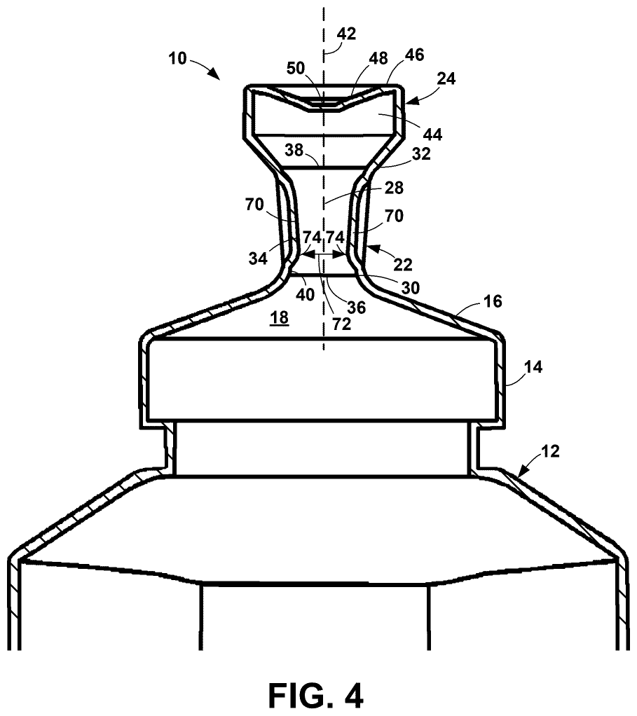

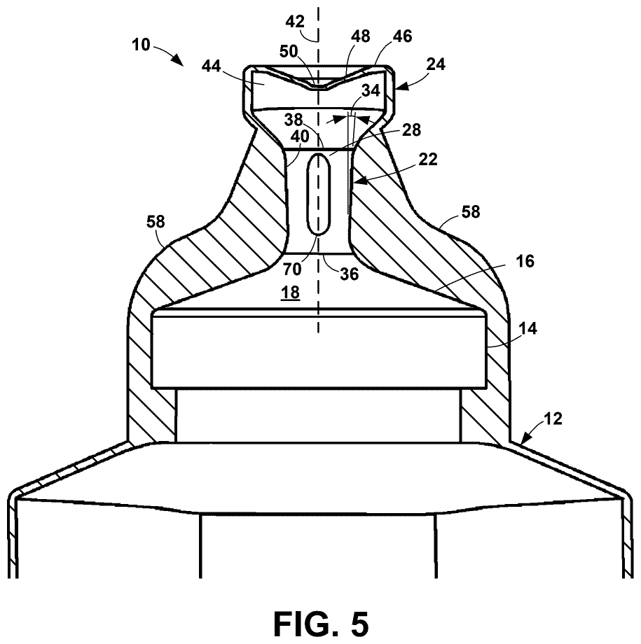

As shown in FIGS. 1-5, the spike port 10 has a neck 22 that extends longitudinally away from the transition 16 from a proximal end 30 at the transition 16 to a distal end 32. The neck 22 is tubular with a taper 26 from the smaller proximal end 30 to the larger distal end 32. The taper 26 is described below.

The neck 22 has a longitudinal bore 28 on an axis 42 and that is contiguous with the container chamber 18. The neck bore 28 tapers, as at 34, from a smaller proximal end 36 to a larger distal end 38. The taper 34 is described below.

A hollow head 24 extends axially from the distal end 32 of the neck 22. The internal cavity 44 of the head 24 is fully enclosed except for being contiguous with the neck bore 28. The wall of the head 24 opposite the neck 22 is the piercing wall 46 that provides access to the contents of the container 12 for a hollow spike 2. A piercing point 50 in the piercing wall 48 is generally axially aligned with the neck bore 28.

Optionally, the piercing point 50 is the most depressed point of a depression 48 in the piercing wall 46. The depression 48 curves into the head cavity 44. Preferably, the depression 48 is round with the piercing point 50 in the center. The purpose of the depression 48 is to generally align the spike 2 with the neck bore 28.

As is well-known in the industry, a BFS container is formed by a mold that is composed of two halves. The two mold parts fit together such that a parting line 56 is formed in the container 12. Opposed gussets 58 are included in the mold at the parting line 56. The gussets 58 extend from the bottom 60 of the head 24 along the neck 22, transition 16, and nozzle seat 14, extending a significant lateral distance from the neck 22, as at 62. The gussets 58 help strengthen the container 12 along the parting line 56.

Optionally, the gussets 58 have ribs 64 that are thicker portions of the gusset 58. The ribs 64 are adjacent to the neck 22. The gussets 58 and ribs 64 help prevent the neck 22 from collapsing axially when the spike 2 is pushed into the port 10.

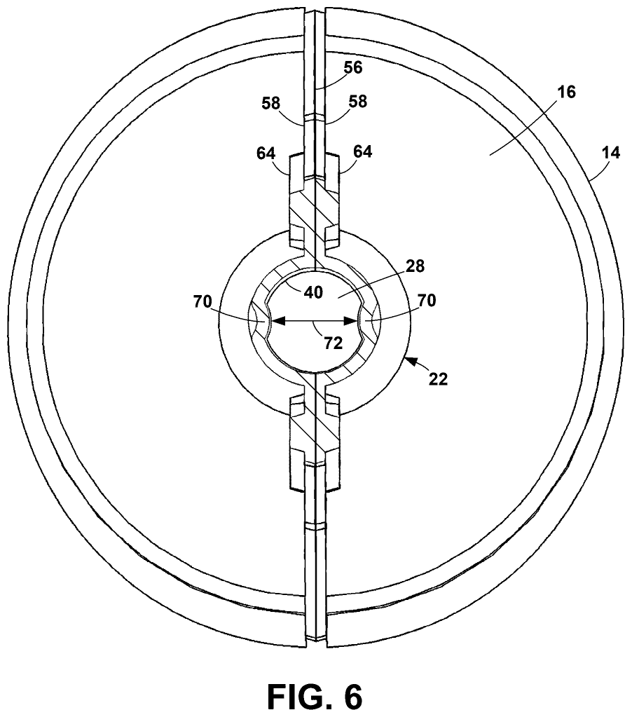

As shown in FIG. 6, a pair of knobs 70 elongated along the length of the bore 28 protrude from the bore wall 40. Preferably, the knobs 70 are positioned 180° around the bore 28 from each other and 90°around the bore 28 from the parting line 56. The knobs 70 narrow the bore 28 as described below.

The present invention is intended for use with a tapered spike 2. The neck bore taper 34 is designed to be 1° to 2° more than the taper 5 of the spike 2 with the distance 72 between the proximal end 74 of the knobs 70 set to match the diameter of the spike 2 near the spike tip 4. For example, a typical spike is 1.5″ long with a 0.225″ diameter at the tip 4 and a 5° taper. For such a spike 2, the neck bore 28 is 0.250″ at the distal end 38 with a 7° taper and the distance 72 between the proximal end 74 of the knobs 70 is approximately 0.240″.

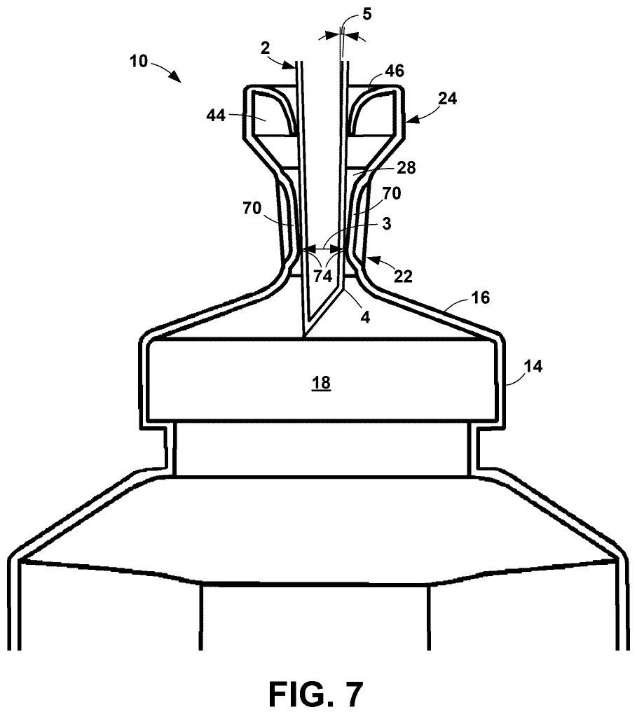

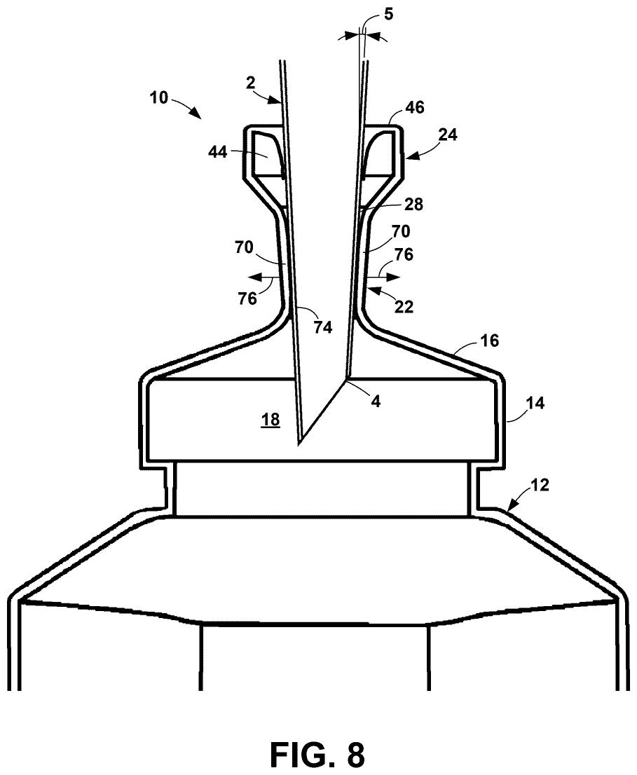

To use, the spike 2 is longitudinally aligned with the piercing point 50 and pushed into the piercing wall 46. The wall 46 parts, allowing the spike 2 through. As the spike 2 penetrates into the bore 28, it contacts the proximal end 74 of the knobs 70 early during insertion, as in FIG. 7. As the spike 2 continues to penetrate the container 12, the tapered spike 2 centers within the bore 26 and pushes the knobs 70 radially outwardly, as at 76 in FIG. 8. The knobs 70 flatten into the bore wall 40 and the bore wall 40 at the parting line 56 collapses against the spike 2, thereby deforming the neck bore taper 34 to match the spike taper 5. The wall 40 collapsing around the spike 2 along the length of the contact between the spike 2 and neck bore wall 40, approximately the length of the knobs 70, seals the bore 28.

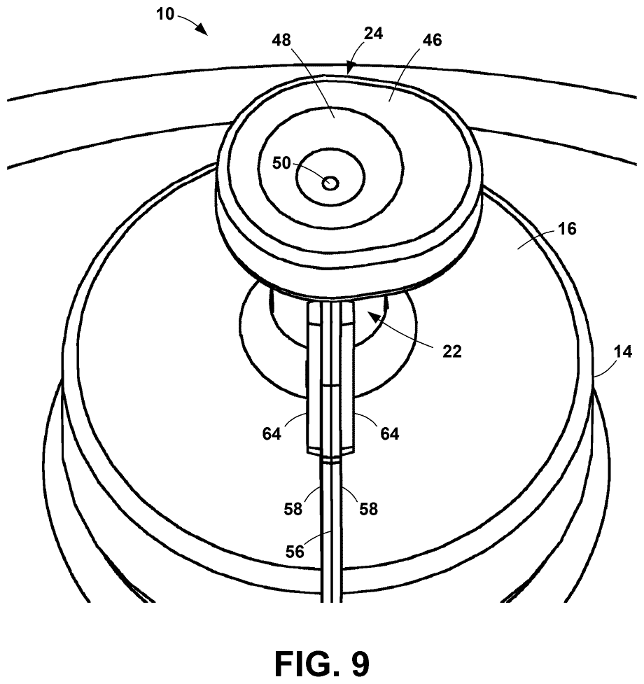

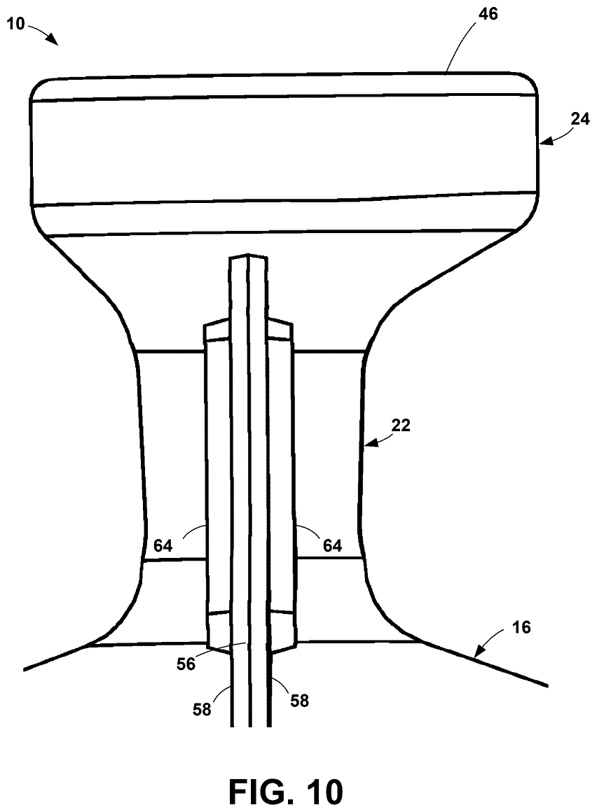

Optionally, the head 24 is stretched perpendicularly to the parting line 56, as in FIGS. 9 and 10. A forming lug in the mold stretches the head 24. Stretching the head 24 causes the parting line 56 to move away from alignment with the neck bore 28. With this, the piercing point 50 is not on the parting line 56 and the excess plastic that can accumulate along the parting point 56 during molding does not make it necessary to increase the amount of effort needed to pierce the piercing wall 46.

Further, moving the parting line 56 away from the piercing point 50 reduces the possibility that the piercing wall 46 will split along the parting line 56 when pierced.

Also, stretching the head 24 thins the material in the area of the piercing point 50, making the piercing wall 46 easier to pierce.

Thus, it has been shown and described a leak proof blow-fill-seal container spike port. Since certain changes may be made in the present disclosure without departing from the scope of the present invention, it is intended that all matter described in the foregoing specification and shown in the accompanying drawings be interpreted as illustrative and not in a limiting sense.

1. A spike port for a blow-fill-seal container having a nozzle seat and a chamber extending into the nozzle seat, the spike port comprising:
(a) a neck extending from a proximal end at the nozzle seat to a distal end;
(b) a bore in the neck, the bore having a wall and an axis and tapering from a narrow proximal end to a wider distal end, the proximal end of the bore being contiguous with the chamber;
(c) elongated knobs protruding radially into the bore from opposite sides of the bore wall; and
(d) a head extending axially from the distal end of the neck, the head having an internal cavity contiguous with the distal end of the bore and a piercing wall opposite the bore, the piercing wall having a piercing point axially aligned with the bore.

2. The spike port of claim 1 wherein the piercing point is the most depressed point of a curved depression in the piercing wall.

3. The spike port of claim 2 wherein the depression is round and the piercing point is in the center.

4. The spike port of claim 1 wherein the knobs are located 90° around the bore from a parting line of the container.

5. The spike port of claim 1 further comprising gussets on the outside of the neck along a parting line.

6. The spike port of claim 5 further comprising thicker ribs within the gussets.

7. A blow-fill-seal container comprising:
(a) a nozzle seat and a chamber extending into the nozzle seat;
(b) a neck extending from a proximal end at the nozzle seat to a distal end;
(c) a bore in the neck, the bore having a wall and an axis and tapering from a narrow proximal end to a wider distal end, the proximal end of the bore being contiguous with the chamber;
(d) elongated knobs protruding radially into the bore from opposite sides of the bore wall; and
(e) a head extending axially from the distal end of the neck, the head having an internal cavity contiguous with the distal end of the bore and a piercing wall opposite the bore, the piercing wall having a piercing point axially aligned with the bore.

8. The blow-fill-seal container of claim 7 wherein the piercing point is the most depressed point of a curved depression in the piercing wall.

9. The blow-fill-seal container of claim 8 wherein the depression is round and the piercing point is in the center.

10. The blow-fill-seal container of claim 7 wherein the knobs are located 90° around the bore from a parting line of the container.

11. The blow-fill-seal container of claim 7 further comprising gussets on the outside of the neck along a parting line.

12. The blow-fill-seal container of claim 11 further comprising thicker ribs within the gussets.
